(19) United States
(12) Patent Application Publication
(10) Pub. No.: US 2014/0149197 A1
(43) Pub. Date: May 29, 2014

(54) Coupon or Voucher Verification Method, System, and Apparatus

(71) Applicants: Woo James, Glen Allen, VA (US); Flora Qian, Glen Allen, VA (US)

(72) Inventors: Woo James, Glen Allen, VA (US); Flora Qian, Glen Allen, VA (US)

(21) Appl. No.: 14/093,312

(22) Filed: Nov. 29, 2013

Related U.S. Application Data
(60) Provisional application No. 61/731,285, filed on Nov. 29, 2012.

(51) Int. Cl. G06Q 30/02

(52) U.S. Cl. CPC G06Q 30/0225
USPC 705/14.26

(57) ABSTRACT

An electronic coupon or voucher display includes a dynamic time-limited visual indicator that permits personnel at a vendor or merchant to confirm the validity of the coupon or voucher based solely on visual inspection of the dynamic time-limited visual indicator, without the need for scanning of the coupon or voucher, input of a coupon or voucher code, or communication with the coupon or voucher issuer. Display of the dynamic time-limited visual indicator is store or location specific and initiated following selection of a store or location, notification that a coupon or voucher is available and indication by the user of an intention to redeem the coupon or voucher, and a determination that the coupon or voucher is accepted at a detected location of the portable electronic device on which the coupon or voucher is to be displayed.

This application claims the benefit of U.S. Provisional Patent Application Ser. No. 61/731,285, filed Nov. 30, 2012.

### BACKGROUND OF THE INVENTION

1. Field of the Invention

The present invention relates to an electronic coupon or voucher validation method and system.

More particularly, the invention relates to an electronic coupon or voucher validation method and system that provides increased flexibility with respect to vendor or merchant participation.

The present invention may be implemented by programmed-hardware or media storing a set of instructions for controlling a display of a smart phone, tablet, or other portable electronic device, the portable electronic device preferably having location detection capabilities, either through an internal GPS device or by receiving location signals/data from an external source.

2. Description of Related Art

Conventionally, electronic coupons or vouchers are printed out or displayed on a smartphone for presentation by a user of the coupon or voucher to a vendor or merchant. The coupon or voucher includes a static identifier in the form of a bar code and/or a numeric code, a printed expiration date, and other terms and conditions such as limitations on vendor or merchant location, and items that may be purchased.

In order to redeem the coupon or voucher and receive a discount, the user presents the coupon or voucher to a waiter, cashier, or sales person, who visually checks the expiration date and any other printed limitations, and then either (a) checks the code against a list of valid codes provided by the coupon or voucher issuer (which is a time-consuming process), or (b) scans the bar code or inputs the printed numerical code into a device for transmission via the Internet or other communication medium to the coupon or voucher issuer, or to a corresponding server and/or database, for authentication and a determination of validity. The validity determination generally involves a check of whether the coupon or voucher has previously been redeemed. Upon receiving confirmation of validity from the coupon or voucher issuer, the coupon or voucher amount is deducted from the total purchase or transaction amount.

In order to accept the coupon or voucher, the vendor or merchant must possess either perform laborious manual code checks or possess a scanner, appropriate software, and the capability of communicating with the coupon or voucher issuer. In general, it is not possible for personnel of the vendor or merchant to determine the validity of the coupon or voucher based solely on its appearance, and thus a vendor or merchant that does not possess the appropriate equipment cannot realize the benefits of offering discounts through electronic coupons or vouchers without considerable cost and/or difficulty, including the cost of training personnel to perform the relatively complex manual code-checking process.

In order to solve this problem, it was proposed in U.S. Provisional Pat. Appl. Ser. No. 61/731,285, incorporated by reference herein, to modify the conventional electronic coupon or voucher display by adding a dynamic validity indicator designed to enable the vendor or merchant, or any other business establishment, to determine the validity of an electronic coupon or voucher based solely on its appearance, i.e., upon visual inspection by personnel of the vendor or merchant. In particular, the dynamic validity indicator permits the vendor or merchant to determine at a glance whether the coupon or voucher has been used previously and is no longer valid, without the need for communication with the coupon or voucher issuer at the time of transaction, or to manually check the validity of a code against a previously-supplied list of valid codes.

The present involves several improvements to this concept, including the addition of a store selection procedure and location determination as a prerequisite to activation of the dynamic validity indicator. The feature of location determination is disclosed in parent U.S. Provisional Pat. Appl. Ser. No. 61/731,285, but is described in greater detail herein.

The term “store” as used in this application is not intended to be limited to a particular structure or type of vendor or merchant, but rather to a geographically-definable venue or site within which the vendor or merchant carries out activities related to its business, and/or at which a coupon or voucher may be redeemed. The “store” may include one or more actual structures, may be located within a multiple-use or multiple vendor structure, or may be a site that is transient, mobile, or outdoors.

The inclusion of store selection and location determination addresses at least three problems with the previously-proposed dynamic validity indicator.

The first is that offering coupons or vouchers on a store-specific basis offers individual vendors or merchants greater flexibility, such as the ability to opt out of parent company sponsored or initiated promotions, to offer promotions tailored to a specific store, neighborhood, or community, and to participate in cross-marketing promotions in association with unrelated vendors or merchants. The method and system of the invention allows store owners when creating a coupon to set the following filters

1. Quantity (total number of coupons)
2. Expiration date
3. Users' geographical range from their store
4. How many times a coupon can be used by a single registered user (multiple or single usage).
Without the store selection feature, companies would have to mandate all stores to virtually participate in a promotion. If the company does not mandate all the stores, then users will be upset when they go to a non-participating store and find out their coupon doesn't work.

The second problem solved by store selection and location determination is to prevent a user from inadvertently activating a dynamic validity indicator at a location that does not accept the electronic coupon or voucher. Since the dynamic validity indicator is only displayed for a finite period of time to prevent re-use of the coupon or voucher, premature activation, or activation at a location that does not accept the coupon or voucher, would result in deactivation of the coupon or voucher before it could be used.

The third problem solved by store selection and location determination is to prevent a user from using a coupon or voucher more than once in different but nearby locations before the dynamic validation display expires and renders the coupon or voucher unusable. By tying activation of the coupon or voucher to a detected location, the invention enables verification of whether the coupon or voucher can actually be used at the user's current location before the dynamic verification display is activated, and also enables the dynamic validation display to be deactivated when the user leaves the detected location.

To further prevent unauthorized multiple uses of coupons or vouchers in different locations, the system and method of the invention may be arranged to include a time stamp that prevents recording and replay of the dynamic verification display by using a video screen capture function or by capturing the dynamic verification display using another electronic device. Such replayed displays would be indistinguishable from the original display and therefore would enable the coupon or voucher to be used multiple times at locations without external verification equipment, but the present invention eliminates this possibility by allowing the vendor or merchant to determine at a glance whether the coupon or voucher had in fact been captured at an earlier time or date.

### SUMMARY OF THE INVENTION

It is accordingly a first objective of the invention provide an improved method, system, or apparatus for displaying and validating an electronic coupon or voucher.

It is a second objective of the invention to provide vendor or merchant with greater flexibility to participate in or opt out of particular promotions by enabling the vendor or merchant to offer coupons or vouchers that are valid only at one or more specific stores or locations, and to opt out of coupons or vouchers valid at other stores or locations.

It is a third objective of the invention provide an improved method, system, or apparatus for displaying and validating an electronic coupon or voucher that prevents a user from inadvertently activating an electronic coupon or voucher when not at a location that accepts the electronic coupon or voucher, and that precludes the electronic coupon or voucher from being used again after use at an authorized location.

It is a fourth objective of the invention to provide a method, system, or apparatus for displaying and validating an electronic coupon or voucher that includes a dynamic validation display and additional misuse prevention features, such as recording prevention.

It is a fifth objective of the invention to provide an improved method, system, or apparatus for displaying and validating an electronic coupon or voucher that does not require any special equipment on the part of the vendor or merchant to which the coupon or voucher is presented, or any changes to the vendor's or merchant's existing transaction/sales/check-out processes or special personnel training, and that includes enhanced misuse prevention features.

It is a sixth objective of the invention to provide a method, system, or apparatus for displaying and validating an electronic coupon or voucher that does not require a vendor or merchant to scan or enter a coupon or voucher code and transmit the code to the coupon or voucher issuer for validation, but that also may optionally be used in conventional fashion by a vendor or merchant that possesses coupon or voucher validation equipment.

These objectives are achieved, in accordance with the principles of the present invention, by modifying an electronic coupon or voucher display to include a dynamic time-limited visual indicator that permits personnel at a vendor or merchant to confirm the validity of the coupon or voucher based solely on visual inspection of the dynamic time-limited visual indicator, without the need for scanning of the coupon or voucher, input or manual checking of a coupon or voucher code, or communication with the coupon or voucher issuer.

In order to provide the vendor or merchant to participate in or opt out of specific promotions, the present invention further includes a store or location selection feature, that limits the display of a coupon or voucher to one or more selected stores. According to this feature of the invention, coupons or vouchers are only displayed following a store selection or registration process that includes the steps of:
(a) upon establishing communications between a user and a web server associated with a service that offers coupons or vouchers, receiving and displaying a list of store locations, followed by the user selecting at least one store location from the list of store locations; and
(b) when a selected store offers a coupon or voucher, the user is informed of the coupon or voucher availability, either by a push notification or upon log-in to the website or server, after which the coupon or voucher may be selected by the user and made available for redemption when the user is within the geographic vicinity of the store.
   It will be appreciated that although the coupon is to be displayed on the user's portable electronic device, the initial communications between the user and web server in step (a), including the selection of stores, may be carried out using any electronic device of the user, and not just the portable electronic device on which the coupon is displayed. In addition, availability of a coupon or voucher in step (b) may be limited to a predetermined period, and may cover one or more selected store locations.

Following the initial store selection and indication of a desire or intention to redeem a coupon or voucher offered by the store, the coupon or voucher redemption process begins with activation and display of the coupon or voucher together with activation of a time-limited visual indicator. Activation preferably begins when the user is at or near a store or location where the coupon or voucher is accepted, and optionally deactivated when the user leaves the store or location. Deactivation may occur immediately or after a predetermined period of time sufficient to enable the user to briefly exit the location (in order to, for example, visit a restroom).

It will be appreciated by those skilled in the art that the term coupon or voucher refers to any document that entitles the bearer to a discount or benefits unavailable to those that do not bear the coupon or voucher. If display of the coupon or voucher is authorized, activation of the dynamic time-limited validity indicator permits personnel of a vendor or merchant to confirm, at the point-of-sale (POS), the validity of the coupon or voucher by visual inspection of the validity indicator, with or without the need for additional validation equipment, and therefore to determine whether the bearer is entitled to the discount or benefits. By taking into account location information, the user is prevented from inadvertently activating the validity indicator at locations that do not accept the electronic coupon or voucher, or from using an activated validity indicator at multiple locations.

It will be appreciated that the invention is not limited to a particular location determination method. Location determination may be based on GPS signals, assisted GPS, cellular triangulation, broadcast location signals, or any other location method or device.

In addition, it is to be appreciated that the time-limited visual indicator is not limited to a particular design. While preferred embodiments of the invention include a running time display, numerous other indicator designs may be used. The key feature of the validity indicator is that it is “dynamic,” i.e., changing, so that the presence and current appearance of the indicator is itself an indication of the validity of the coupon or voucher.

In a various preferred embodiments of the invention, the dynamic time-limited visual indicator may take the form of a running clock or stopwatch time display that counts down the time to expiration, a bar whose length indicates time remaining, a flashing light indicator whose color indicates the validity status of the coupon or voucher, and any other dynamic or changeable indicators from which the coupon or voucher can be determined by visual inspection such as, by way of example and not limitation, a blinking screen of the portable electronic device, icons that float around, cartoons or video clips, etc.

The location determination that precedes display of the dynamic time-limited visual indicator may be initiated whenever the user of the portable electronic device presses a “redeem” button or otherwise indicates an intention to present the coupon or voucher to a merchant. Upon determination that a current location is an authorized location for use of the coupon or voucher, a count is initiated. When the count reaches zero in case of a countdown (or a predetermined count/time if the count is an increasing count or elapsed time), the visual indicator is no longer displayed, stops being dynamic, and/or changes to an indication of invalidity. As a result, the electronic coupon or voucher with the dynamic time-limited visual indicator will be accepted as a valid coupon or voucher so long as the visual indicator is present and changing, and deemed to be invalid if the visual indicator is not present, stops changing, or turns into an indicator of invalidity.

In addition to display of an electronic coupon or voucher with a time-limited dynamic visual indication of validity that is linked to current location, the method, apparatus, and system of the invention may include such features as a time stamp to prevent recording of the time-limited dynamic visual indicator.

Still further, in an alternative preferred embodiment of the invention, additional verification of validity may be performed by communicating with the coupon or voucher issuer or an appropriate server/database before or after the location verification, and before the time-limited dynamic visual validity indicator is displayed, and by displaying the time-limited dynamic visual validity indicator only upon receiving confirmation of validity from the coupon or voucher issuer. This alternative preferred embodiment has the advantage of providing the same positive confirmation of validity currently provided by the vendor or merchant's coupon or voucher validation equipment, but that utilizes the built-in communication capabilities of the user's portable device rather than equipment that must be purchased and installed by the vendor or merchant.

The term “validity” as used herein generally refers to whether the electronic coupon or voucher has previously been redeemed and the discount already taken. However, validation may also include a check of coupon or voucher expiration date, whether the coupon or voucher is valid at the POS location, and any other conditions that affect whether the user of the portable electronic device is entitled to a discount when presenting the coupon or voucher. In the case of a multi-use coupon or voucher, validation may involve a determination of the number of times the coupon or voucher has been used, rather than a simple determination of use, and the time-limited dynamic display may be arranged to appear multiple times, with a counter keeping track of the number of uses.

In an especially preferred embodiment of the invention, the portable electronic device is a smartphone or tablet-type computer, and the method, system, and apparatus are implemented by means of a downloaded coupon or voucher display applet, which is stored in and implemented by programmable hardware in the smartphone or tablet. When a user wishes to redeem a an electronic coupon or voucher, the user selects the applet or “app,” which displays a selection of available electronic coupons or vouchers, either previously downloaded and stored in the portable device, in a Internet-based database or “cloud storage,” or available for purchase through a communication link to the coupon or voucher issuer's website. Upon selection of an electronic coupon or voucher for redemption, the electronic coupon or voucher may optionally be validated by establishing communications between the app and the coupon or voucher issuer.

If validation is confirmed, or if the validation step is omitted, the app displays the electronic coupon or voucher together with a dynamic time-limited indication of validity on a display screen of the smartphone, tablet, or other electronic device, and the user shows the display to the vendor or merchant, who upon visual inspection of the dynamic validity indication will deduct the coupon or voucher amount from the purchase price without the need for further validation. When the user leaves the location of the transaction, or after a predetermined period, the display is terminated and the coupon or voucher marked by the app as invalid or expired and/or disappears from the coupon or voucher depository or storage.

### BRIEF DESCRIPTION OF THE DRAWINGS

FIGS. 1A and 1B show a smartphone coupon or voucher display with dynamic time-limited visual validity indicator at respective first and second points of time, according to a preferred embodiment of the invention.

FIGS. 1C and 1D show the same coupon or voucher as FIGS. 1A and 1B, but with an additional geographic location display.

FIG. 2A is a flow chart showing a store-specific coupon or voucher display and presentation method for implementation on a portable electronic device, according to a preferred embodiment of the invention.

FIG. 2B and 2C are flowcharts showing details of the coupon or voucher redemption procedure of FIG. 2A, for controlling a display such as the one illustrated in FIGS. 1A and 1B.

FIGS. 3A-3C show dynamic time-limited visual validity indicators that are alternative to the dynamic time-limited visual validity indicators of FIGS. 1A-1D.

### DETAILED DESCRIPTION OF THE PREFERRED EMBODIMENTS

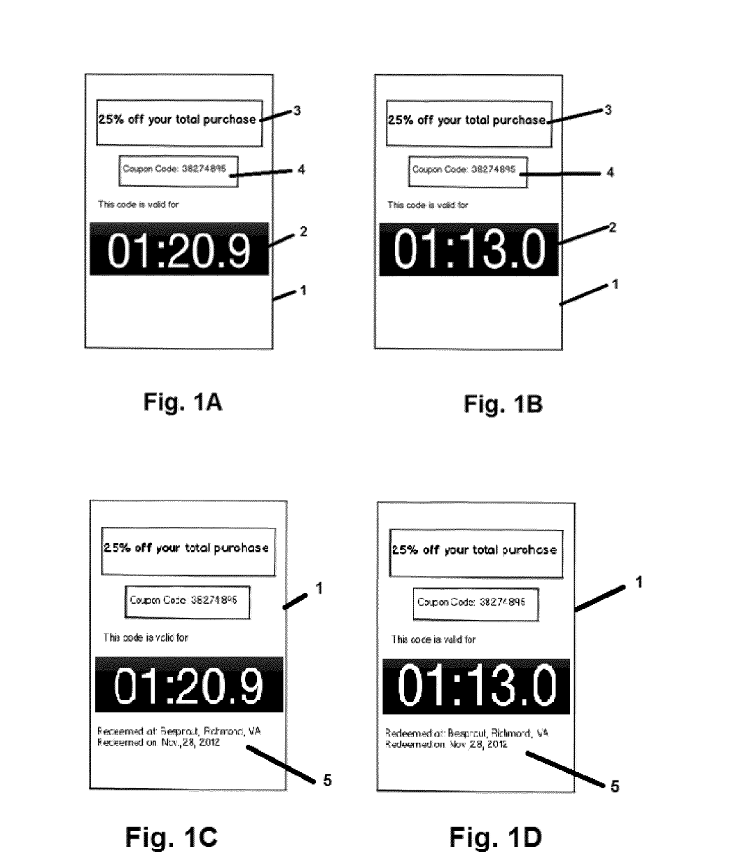

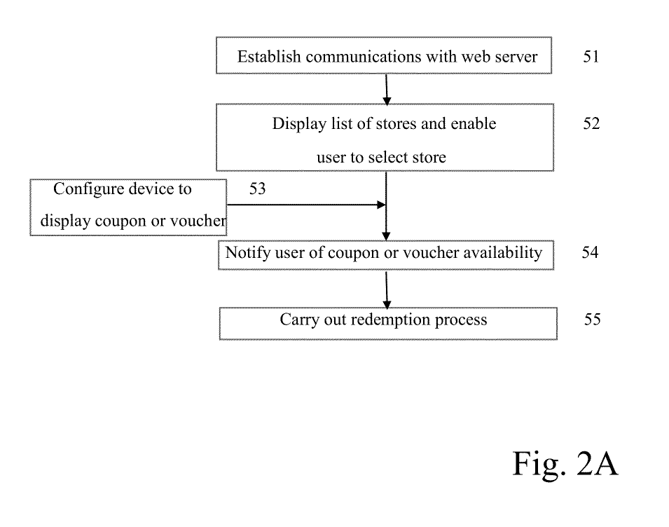

FIG. 1 shows a display screen 1 of a smartphone, tablet, or other portable device, arranged in accordance with the principles of a preferred embodiment of the invention. The display 1 is controlled by programmed-hardware such as a smartphone controller or integrated circuit, the hardware being programmed to execute a set of control instructions or “app” downloaded to the smartphone from an external server or device, and stored in a memory within the portable device.

The display screen 1 is illustrated as displaying an electronic coupon or voucher. Electronic coupons or vouchers of the type illustrated in FIGS. 1A and 1B are well known, and include coupons or vouchers issued under the names Groupon™, Living Social™, Amazon.com™, Bloomspot™, and so forth. Except for the inclusion of a dynamic time-limited validity indication 2, the design of the coupon or voucher forms no part of the present invention. Instead, the method, system, and apparatus of the invention are applicable to any electronic coupon or voucher with a dynamic time-limited validity indication irrespective of the particular design, issuer, or use.

In the preferred embodiment, the display is generated entirely by programmed-hardware within the portable communication device, although it is also within the scope of the invention to generate the display at a server for display within the coupon or voucher display app or a web browser of the portable communication device.

Typical electronic coupons or vouchers may include an indication of the amount of the discount to be applied upon presentation of the coupon or voucher (indicated by block 3) and a coupon or voucher code (indicated by block 4) that may be input by personnel at the vendor or merchant to a device arranged to communicate with the coupon or voucher issuer or a corresponding server/database for coupon or voucher verification. In addition, a typical coupon or voucher will include text providing a static expiration date, the name of the merchant and, if applicable, the particular location or branch at which the coupon or voucher many be used, the items to which the discount applies, and other terms and conditions for using the coupon or voucher, as well as the name and logo of the coupon or voucher issuer. Still further, the coupon or voucher may include a bar code instead of or in addition to the numeric code, the bar code enabling the merchant to scan the coupon or voucher directly into a device that communicates with the coupon or voucher issuer or a corresponding server/database for verification of the coupon's or voucher's validity. The present invention is intended to apply to an electronic coupon or voucher with any of the above-described features.

Although the electronic coupon or voucher of the invention may be used in situations where the merchant does not have equipment, such as a scanner and communications device, capable of performing coupon or voucher verification, the electronic coupon or voucher to which the invention is applied may still include a bar code and/or numeric verification code so that the coupon or voucher can be used both by vendors or merchants with validation equipment and in establishments that lack such validation equipment.

As illustrated in FIGS. 1A-1D, the dynamic time-limited coupon or voucher validity verification display 2 of the preferred embodiment is in the form of a running clock, depicted as a digital clock, for indicating the amount of time remaining before the redemption period ends and the dynamic time-limited validity verification display no longer is present or ceases to indicate that coupon is valid. FIGS. 1A and 1C show the running clock at a first moment in time, and FIGS. 1B and 1D show the running clock as a second moment in time, after 7.9 seconds (or 7-9 minutes) have elapsed. FIGS. 1C and 1D differ from FIGS. 1A and 1B in that the coupon or voucher 1 shown therein includes a display 5 of the location of the establishment in which the coupon is being redeemed and a display of the current date. By including the date display, and/or a corresponding display of the time that the running clock is being displayed in order to redeem the coupon, it becomes impossible for a recording of the running clock display to be used for validation since the recording will capture the date and/or time of redemption and thereby prevent use of the recorded coupon or voucher on a different date or at a different time.

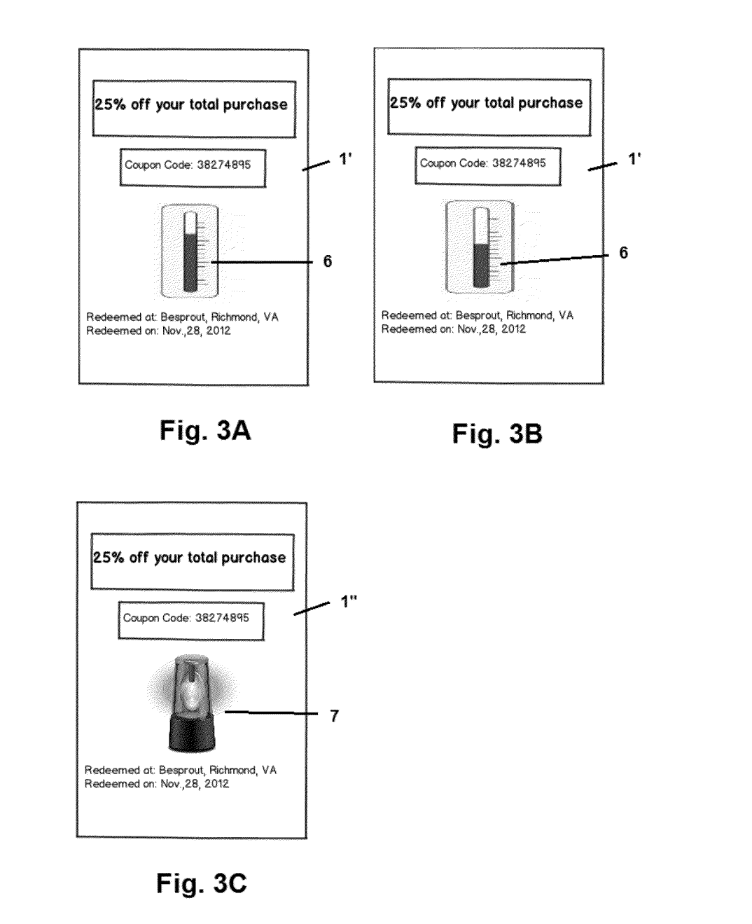

Instead of a digital clock, the dynamic time-limited coupon or voucher validity verification display 2 may take the form of an analog clock display, or any other time indicator, such as a bar with a position indicator that moves from one side to the other to indicate remaining time, or a bar that decreases in length as time elapses. The latter type of indicator is indicated by reference numeral 6 in FIGS. 3A and 3B, which show a coupon or voucher 1′ that is otherwise identical to those shown in FIGS. 1C and 1D, or may take other forms.

Furthermore, the dynamic visual indicator of the invention is not limited to a time display, but rather is intended to include any dynamic display that can be observed by vendor or merchant personnel. By way of example, the dynamic visual indicator may take the form of a color changing design, such as the flashing light 7 of FIG. 3C, which may change color from green to yellow to red as the end of the redemption time period approaches. Again, the coupon or voucher 1″ shown in FIG. 3C may be identical to the coupons or vouchers shown in FIGS. 1C and 1D, or may take other forms.

Irrespective of the type of dynamic time-limited visual validity indicator, the dynamic display is only presented during a period of time that begins with pressing of a “redeem” button by the user, or that begins with another user input that indicates an intention to use the coupon or voucher within a predetermined time period, and ends when the time period ends (for example, in the case of a stopwatch type running clock display, when the running clock counts down to zero). Other user inputs that initiate the display may include, by way of example and not limitation, a voice input that makes use of speech recognition, the entry of a code or PIN by the user, and so forth.

Once the display counts down to zero, the redemption time elapses, and/or the user leaves the location of the transaction, the display may either disappear from the screen or turn into a static display indicating that the time has elapsed such as, by way of example and not limitation, a clock display of all zeros, or a text message stating that the coupon or voucher is invalid.

Optionally, the coupon or voucher display control may communicate with the coupon or voucher issuer or a corresponding server/database after pressing of the “redeem” button or an equivalent input by the user and before starting the running clock. The communication, which may be carried out by conventional communications means on the portable electronic device, such as a wireless cellular connection or a WiFi connection, requests verification of the coupon or voucher based on a code unique to the coupon or voucher for which verification is requested, and which is downloaded or included with the coupon or voucher when the coupon or voucher is purchased. The communication may refer to a GPS location of the portable device if the coupon or voucher is only valid at particular locations. Only if the coupon or voucher issuer or corresponding server/database returns an indication that coupon or voucher is valid will the running clock display be started.

Alternatively, the portable device may perform one or more internal validity comparisons or checks before starting the dynamic validity indicator display. For example, the portable device may compare a stored coupon or voucher expiration date with the current date and/or a usage limit with a count of the number of times the coupon or voucher has been used if multiple uses are permitted. In addition, to provide additional security for the coupon or voucher user, the user might be required to input a PIN before the coupon or voucher can be used.

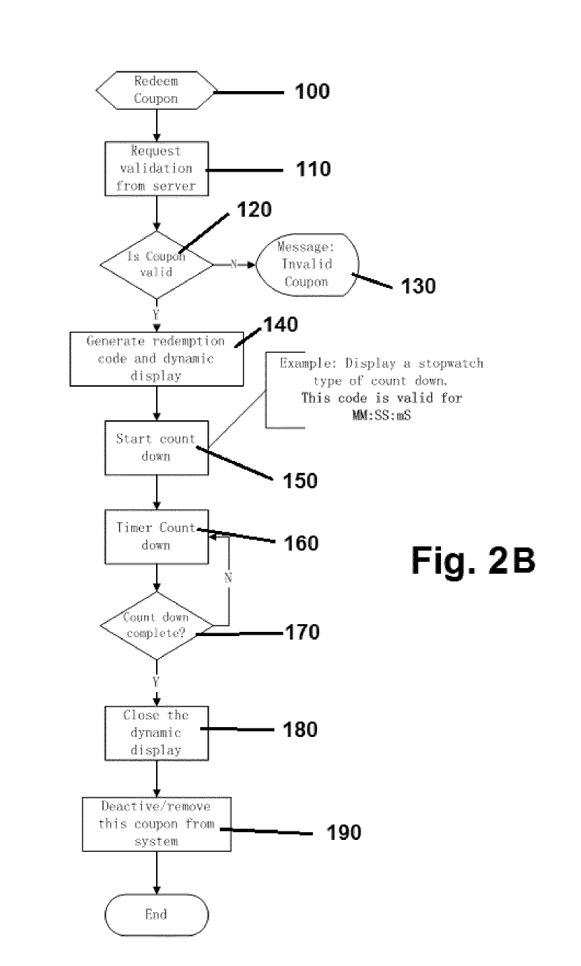

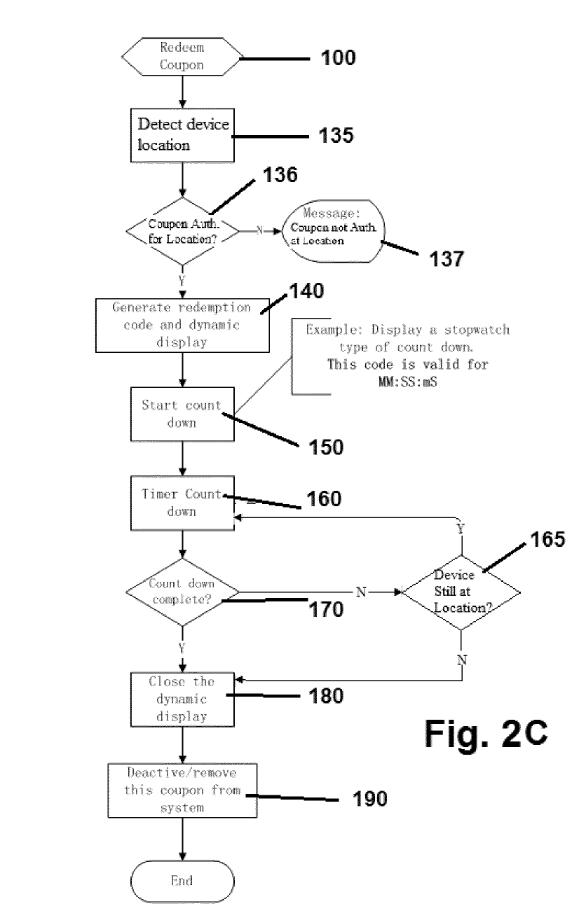

FIG. 2A is a flowchart of the overall method by which coupons or vouchers are presented and redeemed on a store or location specific basis according to a preferred embodiment of the invention.

The first step of the method (step 50) is for the user to establishing communications with a web server associated with a service that offers coupons or vouchers. This step may be initiated following a visit to a company website, downloading of an application or hyperlinking to the website in response to an advertisement or scanning of a bar code, or any other action that directs the user to the website.

The second step of the method (step 51) is to display a list of stores, and to enable the user to select one or more of the stores, for example by point-and-click or other conventional selection routines. The selected store or stores are then stored in an application program on the user's portable electronic device, in a database on the server for retrieval by the portable electronic device, or both, for future reference when it is desired to redeem a coupon and/or when a coupon becomes available.

It will be appreciated that before a coupon or voucher can be redeemed by display on a portable electronic device of the user, the device must be configured to display the coupon or voucher (step 52). Step 52 conventionally involves downloading of an applet or application program to the portable electronic device, which may occur before or after steps 50 and 51. If the application program is downloaded before steps 50 and 51, then the list of store locations may be displayed on the display screen of the portable electronic device, and selection may be carried out under control of the applet or application program downloaded to the portable electronic device, which may store the selected stores or locations on the device and/or upload the selected locations to a server.

At the time of selection, or at any time thereafter when a coupon or voucher becomes available, the user is notified of the availability of a coupon or voucher for redemption at the selected store or location (step 53). The notification may be in answer to a query initiated by the user or a push notification that is automatically sent to the user, and may optionally be in response to detection by the user's portable electronic device that the user is in the vicinity of the store or location. The notification may take the form of a “redeem” button display, a list of available coupons or vouchers from which a desired coupon or voucher can be selected, or a link to such a redeem button or list.

Finally, if a coupon or voucher is available and the user indicates an intention to redeem (step 54), the redemption process is carried out (step 55).

FIG. 2B is a flowchart of an exemplary implementation of the redemption process of FIG. 2A, step 55. In step 100 of FIG. 2B, the user of the portable device initiates a coupon or voucher display and selects a displayed “redeem” button, or otherwise inputs an indication that the user wishes to redeem the coupon or voucher. Appropriate programmed hardware in the portable device then initiates communication with the coupon or voucher issuer and requests validation (step 110). Upon receipt of response from the coupon or voucher issuer (step 120), the display control hardware either displays a message indicating that the coupon or voucher is invalid (step 130) or it displays the electronic coupon or voucher and dynamic time-limited validity indicator (step 140).

As illustrated in FIG. 2B, step 140 not only includes generation of a dynamic time-limited visual validity indication corresponding to the validity indication 2 illustrated in FIGS. 1A and 1B, but also a redemption code corresponding to the redemption code 4 shown in FIGS. 1A and 1B. Those skilled in art will appreciate, however, that the redemption code may be omitted in situations where the merchant performs no verification other than checking of the dynamic time-limited visual display. In addition, if a redemption code is displayed, it may be a code that is acquired at the time the coupon or voucher is purchased, received from the coupon or voucher issuer at the time of verification, or generated by the portable device based on stored information and/or information received from the coupon or voucher issuer at the time of verification. Other features of the displayed coupon or voucher may also be generated at the same time as the optional code generation.

Once the display is generated, the display controller begins counting, and displays a dynamic visual indicator such as the display of remaining time shown in FIGS. 1A-1D or the displays shown in FIGS. 3A-3C (step 150). By way of example, the count may be of minutes, seconds, and tenths of a second, although other time units may be used. Alternatively, although not preferred, it may be possible in the case of a time display such as the one shown in FIGS. 1A-1D to display time indications other than “time remaining,” such as time-elapsed from pressing of the redemption button. A time-elapsed display would be less intuitive or convenient for both the user and personnel of the vendor or merchant than a time-remaining display, but the display could still be made to freeze or disappear when a predetermined amount of time had elapsed and therefore would still be within the scope of the invention.

Display of the dynamic visual indicator continues, as indicated by step 160, until completion of the time period for redemption, as indicated by step 170, at which time the dynamic display is either converted to a static display or caused to disappear as described above (step 180). The coupon or voucher is then deactivated or deleted from the portable device (step 190) and the coupon or voucher issuer optionally notified, thus ending the method illustrated in FIG. 2A. Once deactivate or deleted, the coupon or voucher can no longer be used.

FIG. 2C shows the same method as FIG. 2B, but which omits the optional server validation request step 110 of FIG. 2A, and which adds steps relating to location detection. In particular, FIG. 2B includes a step 135 of detecting a location of the portable electronic device on which the coupon is to be displayed, and verifying in step 136 that the electronic coupon or voucher is authorized for use at the detected location, followed either by initiation in step 140 of the dynamic display if it is determined that used of the coupon or voucher is authorized at the detected location, or by display in step 137 of a message that use of the coupon or voucher is not authorized. The location detection step 135 is not limited to a particular type of location detection, but rather may include both GPS-based location determining methods and equipment or methods that involve communications with an earth-bound server or signal source, including cellular location methods, or even input by a user of a current address or location name. Furthermore, the authorized location(s) against which the detected location is compared may be pre-stored with the electronic coupon or voucher, obtained by communications/querying an external server or information source, for example during the “request validation” step 110 illustrated in FIG. 2B, or acquired in any other fashion including scanning of a list or barcode providing information on authorized location.

In addition to the location determination and validation step 135, FIG. 2C shows an optional location-based display deactivation procedure (steps 165 and 166) in which the display is deactivated or closed when the user leaves the location where the coupon is accepted, thereby preventing the user from reusing the coupon or voucher at a different location before the dynamic display would otherwise expire. It will be appreciated that the term “location” is not limited to the physical walls of a particular business, but rather may encompass an area around the business, with the size of the area depending on the nature of the coupon or voucher and the business itself.

Having thus described preferred embodiments of the invention in sufficient detail to enable those skilled in the art to make and use the invention, it will nevertheless be appreciated that numerous variations and modifications of the illustrated embodiment may be made without departing from the spirit of the invention. Accordingly, it is intended that the invention not be limited by the above description or accompanying drawings, but that it be defined solely in accordance with the appended claims.

I claim:

1. A method of controlling displaying an electronic coupon or voucher on a display screen of a portable electronic device, comprising the steps of:
selection by a user of a store or location;
when a coupon or voucher is available for redemption at the store or location, and upon input by a user signaling an intention to redeem the electronic coupon or voucher, generating, by a display controller of the portable electronic device, an electronic coupon or voucher display on the display screen of the electronic portable device, said electronic coupon or voucher display including a time-limited dynamic visual validity indication;
upon expiration of a predetermined period of time from said input by the user, causing said time-limited dynamic visual validity indication to become static or disappear from said display screen of the portable electronic device,
wherein when said user shows said electronic coupon or voucher to personnel of a vendor or merchant, said personnel determines by visual inspection, based on the presence of said time-limited dynamic visual validity indication, whether said coupon or voucher is valid.

2. A method as claimed in claim 1, further comprising the step of verifying that the portable electronic device is at or near a selected store or location that accepts the coupon or voucher to be redeemed.

3. A method as claimed in claim 1, wherein said time-limited dynamic visual validity indication provides an indication of time remaining before expiration.

4. A method as claimed in claim 2, wherein said indication of time remaining is displayed as a running clock display.

5. A method as claimed in claim 1, wherein said electronic coupon or voucher further includes a numeric code or barcode so that the coupon or voucher may be validated both by a vendor or merchant that possesses validity verification equipment and by a vendor or merchant that does not possess such equipment.

6. A method as claimed in claim 1, further comprising the step of, before generating and displaying said time-limited visual validity indication, the portable electronic device transmitting a coupon or voucher code to a remote server or database for confirmation of validity.

7. A method as claimed in claim 1, further comprising the step of including in the electronic coupon or voucher display a display of a current date and/or time.

8. A method as claimed in claim 1, wherein the portable electronic device is a smartphone or tablet-type computer, and said display is generated based on instructions included in a downloaded applet.

9. A method as claimed in claim 1, wherein said location determining step utilizes a GPS device or component.

10. A method as claimed in claim 1, further comprising the step of terminating the time-limited visual validity indication display if it is determined that the portable electronic device has left a detected location.

11. A system for controlling displaying an electronic coupon or voucher on a display screen of a portable electronic device, comprising:
programmed display control hardware that executes the following display control instructions:
when a coupon or voucher is available for redemption at the store or location, and upon input by a user signaling an intention to redeem the electronic coupon or voucher, generating, by a display controller of the portable electronic device, an electronic coupon or voucher display on the display screen of the electronic portable device, said electronic coupon or voucher display including a time-limited dynamic visual validity indication;
the programmed display-control hardware also generating a time-limited dynamic visual validity indication for inclusion in the electronic coupon or voucher display;
upon expiration of a predetermined period of time from said input by the user, causing said time-limited dynamic visual validity indication to become static or disappear from said display screen of the portable electronic device,
whereby when said user shows said electronic coupon or voucher to personnel of a vendor or merchant, said personnel determines by visual inspection, based on the presence of said time-limited dynamic visual validity indication, whether said coupon or voucher is valid.

12. A system as claimed in claim 11, further comprising a geographic location determining device for verifying that the portable electronic device is at or near a selected store or location that accepts the coupon or voucher to be redeemed.

13. A system as claimed in claim 11, wherein said time-limited dynamic visual validity indication provides an indication of time remaining before expiration.

14. A system as claimed in claim 12, wherein said indication of time remaining is displayed as a running clock display.

15. A system as claimed in claim 11, wherein said electronic coupon or voucher further includes a numeric code or barcode so that the coupon or voucher may be validated both by a vendor or merchant that possesses validity verification equipment and by a vendor or merchant that does not possess such equipment.

16. A system as claimed in claim 11, wherein the programmed-hardware further executes instructions for, before generating and displaying said time-limited visual validity indication, transmitting a coupon or voucher code form the portable electronic device to a remote server or database for confirmation of validity.

17. A system as claimed in claim 11, wherein the programmed-hardware further executes instructions for, generating a date and/or time stamp for inclusion in the electronic coupon or voucher display.

18. A system as claimed in claim 11, wherein the portable electronic device is a smartphone or tablet-type computer, and said instructions are included in a downloaded applet.

19. A system as claimed in claim 11, wherein said location determining instructions utilize a GPS device or component.

20. Apparatus for carrying out the method of claim 1.
